(19) United States
(12) Patent Application Publication
(10) Pub. No.: US 2017/0274549 A1
(43) Pub. Date: Sep. 28, 2017

(54) Trim Cover Perforating Apparatus and Method

(71) Applicant: Lear Corporation, Southfield, MI (US)

(72) Inventor: Douglas S. Sculthorpe, El Paso, TX (US)

(21) Appl. No.: 15/079,821

(22) Filed: Mar. 24, 2016

(51) Int. Cl. B26F 1/14; B26D 7/00; C14B 5/00; B26D 5/00

(52) U.S. Cl. CPC B26F 1/14; B26D 5/005; B26D 7/0006; C14B 5/00

(57) ABSTRACT

A trim cover perforating apparatus and a method of perforating a trim cover. The trim cover perforating apparatus may have a plurality of punches that may be received in punch openings of a punch lifting plate. The punch lifting plate may receive a pattern plate that may have a set of pattern plate holes. Each punch that is aligned with a pattern plate hole may not perforate the trim cover. Each punch that is not aligned with a pattern plate hole perforates the trim cover.

### TECHNICAL FIELD

This disclosure relates to a trim cover perforating apparatus and a method of perforating a trim cover.

### BACKGROUND

An apparatus and method for perforating leather using perforation tiles is disclosed in U.S. Patent Publication No. 2015/0000485.

### SUMMARY

In at least one embodiment, a trim cover perforating apparatus is provided. The trim cover perforating apparatus may include a punch lifting plate, a cutting plate, a plurality of punches, and a pattern plate. The punch lifting plate may have a pattern plate retaining region and a plurality of punch openings that extend from the pattern plate retaining region. The cutting plate may support a trim cover such that the trim cover is disposed between the cutting plate and the punch lifting plate. The punches may be received in the punch openings. Each punch may have a punch head that may be disposed proximate the punch lifting plate. The pattern plate may be received in the pattern plate retaining region. The pattern plate may have a set of pattern plate holes. Each punch that is aligned with a pattern plate hole may move into the pattern plate hole and may not perforate the trim cover when the pattern plate is actuated toward the trim cover. Each punch that is not aligned with a pattern plate hole perforates the trim cover when the pattern plate is actuated toward the trim cover.

In at least one embodiment, a method of perforating a trim cover with a trim cover perforating apparatus is provided. The method may include positioning a trim cover on a cutting plate of the trim cover perforating apparatus. An upper portion of the trim cover perforating apparatus having punch lifting plate that receives a plurality of punches and a pattern plate may be actuated from a first position to a second position. The punches may not engage the trim cover when the upper portion is in the first position. At least some of the punches may perforate the trim cover when the upper portion is in the second position. The pattern plate may have a set of pattern plate holes that may be aligned with some of the punches. Each punch that is aligned with a pattern plate hole does not perforate the trim cover. Each punch that is aligned with a pattern plate hole perforates the trim cover.

### BRIEF DESCRIPTION OF THE DRAWINGS

FIG. 1 is an illustration showing a trim cover perforating apparatus.

FIG. 2 is a fragmentary perspective view of a portion of the trim cover perforating apparatus.

FIG. 3 is a section view of the trim cover perforating apparatus along section line 3-3 showing the trim cover perforating apparatus in a first position.

FIG. 4 is a section view of the trim cover perforating apparatus in a second position.

FIG. 5 is a perspective view of an example of a pattern plate that may be provided with the trim cover perforating apparatus.

FIG. 6 is a flowchart of a method of perforating a trim cover.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

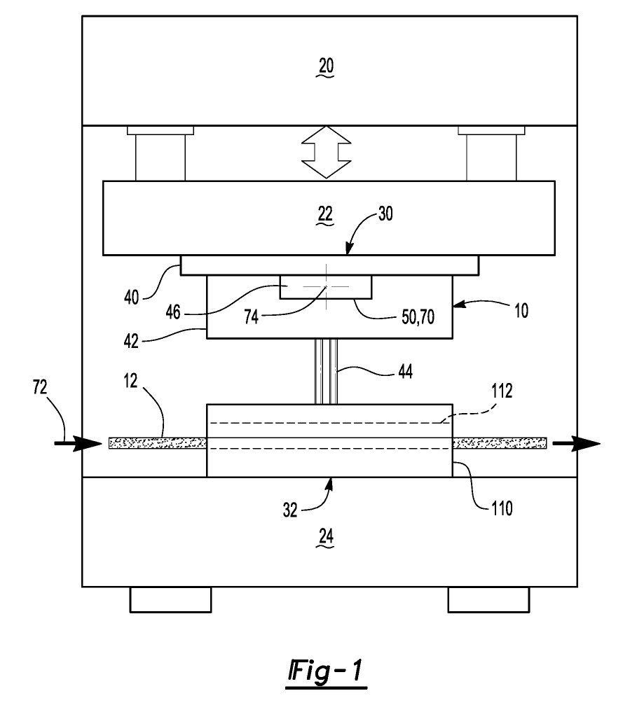

Referring to FIG. 1, an example of a trim cover perforating apparatus 10 is shown. The trim cover perforating apparatus 10 may be configured to perforate or punch holes in a trim cover 12. The trim cover 12 may then be provided to form an exterior surface of a seat assembly. The trim cover 12 may be made of any suitable material, such as vinyl, leather, or combinations thereof.

The trim cover perforating apparatus 10 may be disposed on a press 20. The press 20 may be configured to actuate the trim cover perforating apparatus 10 to perforate the trim cover 12. The press 20 may be of any suitable type. For instance, the press 20 may be a mechanical press or a hydraulic press that may be actuated by pressurized hydraulic fluid. In at least one embodiment, the press 20 may include a ram 22 and a bed 24.

The ram 22 may be an upper portion of the press 20. The ram 22 may be disposed above the bed 24 and may be configured to move with respect to the bed 24. For example, the ram 22 may be configured to move in a generally linear manner toward or away from the bed 24.

The bed 24 may be a lower portion or base of the press 20. The bed 24 may be stationary and may support at least a portion of the trim cover perforating apparatus 10.

The trim cover perforating apparatus 10 may be disposed on the press 20. The trim cover perforating apparatus 10 may have multiple components that may facilitate perforating of the trim cover 12. More specifically, the trim cover perforating apparatus 10 may provide perforations in a desired pattern in the trim cover 12. This pattern may be controlled by the configuration of a pattern plate as will be discussed in more detail below. In at least one embodiment, the trim cover perforating apparatus 10 may include an upper portion 30 and a lower portion 32.

The upper portion 30 may be mounted to the ram 22. As such, the upper portion 30 may move with the ram 22 and may move with respect to the bed 24, the trim cover 12, and the lower portion 32 to perforate the trim cover 12 as will be discussed in more detail below. In at least one embodiment, the upper portion 30 may include a top plate 40, a punch lifting plate 42, a plurality of punches 44, and a pattern plate 46.

The top plate 40 may be fixedly positioned with respect to the ram 22. For instance, the top plate 40 may be mounted on a surface of the ram 22 that faces toward the bed 24.

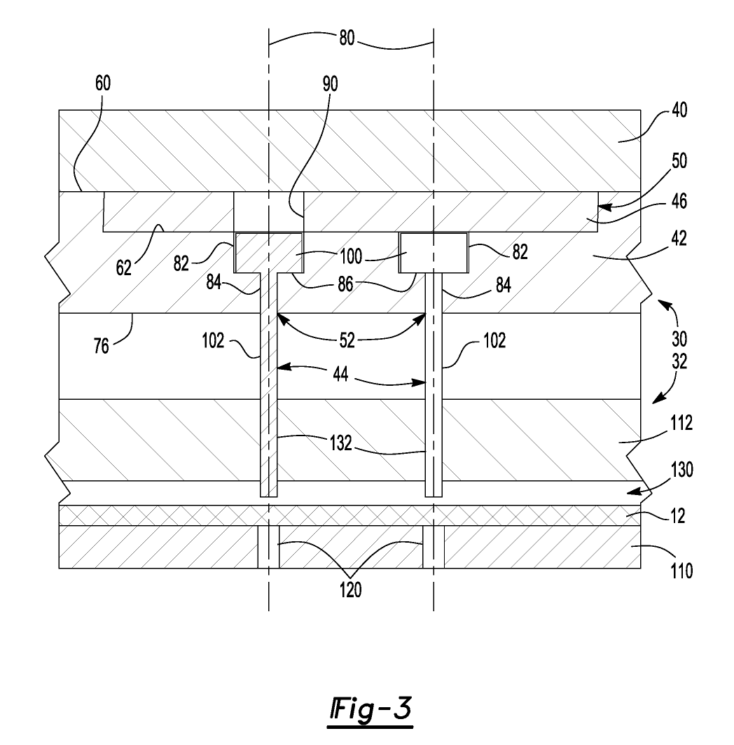

The punch lifting plate 42 may be fixedly positioned with respect to the top plate 40. For example, the punch lifting plate 42 may be mounted on the top plate 40 and may extend from the top plate 40 toward the bed 24. The punch lifting plate 42 may be configured to receive the punches 44 and the pattern plate 46. As is best shown with reference to FIGS. 1 and 3, the punch lifting plate 42 may include a pattern plate retaining region 50 and a plurality of punch openings 52.

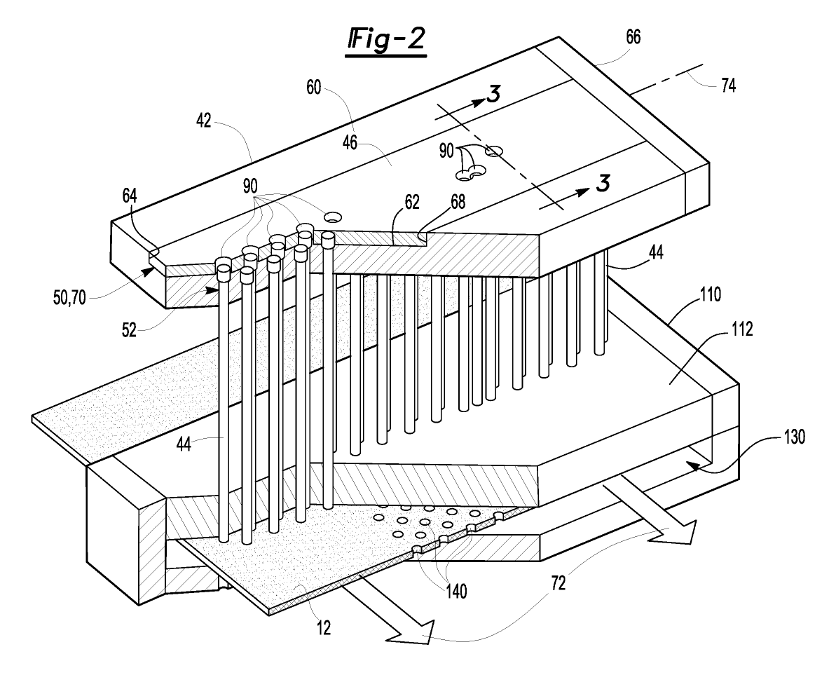

The pattern plate retaining region 50 may be configured to receive and facilitate positioning of the pattern plate 46. The pattern plate retaining region 50 may be at least partially defined by the punch lifting plate 42; however, it is also contemplated that the pattern plate retaining region 50 may be completely defined in the punch lifting plate 42. In the configuration shown in FIGS. 1-3, the top plate 40 and the punch lifting plate 42 cooperate to define the pattern plate retaining region 50. For instance, the pattern plate retaining region 50 may be configured as a slot and extend from a top surface 60 of the punch lifting plate 42 to a bottom slot surface 62. The top surface 60 may be disposed proximate and may engage the top plate 40. As is best shown in FIG. 2, a first side wall 64, a second side wall 66, and a third side wall 68 may extend from the top surface 60 to the bottom slot surface 62. As is best shown in FIG. 3, the bottom slot surface 62 may be disposed opposite the top plate 40.

Referring to FIGS. 1 and 2, the pattern plate retaining region 50 may have an open end or opening 70 through which the pattern plate 46 may be inserted or removed. In the configuration shown in FIGS. 1 and 2, the top plate 40 and the punch lifting plate 42 cooperate to define the opening 70; however, it is contemplated that the opening 70 may be completely defined in the punch lifting plate 42 in one or more embodiments. The opening 70 may be disposed opposite the second side wall 66 of the punch lifting plate 42 and may have a shape and size that may facilitate insertion and removal of the pattern plate 46 from the pattern plate retaining region 50. As is best shown in FIG. 1, the opening 70 may be provided along a side of the punch lifting plate 42 that may be disposed at a nonparallel angle with respect to a feed direction 72 of the trim cover 12. For example, the opening 70 may be positioned along a slot axis 74 that may be disposed substantially perpendicular to the feed direction 72. As such, the first side wall 64 and the third side wall 68 may inhibit movement of the pattern plate 46 parallel to the feed direction 72 while the second side wall 66 may engage an end of the pattern plate 46 and act as a stop that limits the distance that the pattern plate 46 can be inserted into the pattern plate retaining region 50.

Referring to FIGS. 2 and 3, a plurality of punch openings 52 may extend from the pattern plate retaining region 50. More specifically, the punch openings 52 may extend from the bottom slot surface 62 and through the punch lifting plate 42 to a bottom surface 76 of the punch lifting plate 42. The punch openings 52 may be spaced apart from each other and may be arranged in one or more rows. In FIG. 2, two linear rows are shown that extends substantially perpendicular to the feed direction 72; however it is contemplated that a greater or lesser number of rows may be provided. As is best shown in FIG. 3, each punch opening 52 may extend along an axis 80 and may have a punch head receiving portion 82 and a punch shaft receiving portion 84.

The punch head receiving portion 82 may extend from the bottom slot surface 62 to the punch shaft receiving portion 84. More specifically, the punch head receiving portion 82 may extend from the bottom slot surface 62 to a bottom punch head receiving portion surface 86. The punch head receiving portion 82 may be configured to receive a head of a punch 44. The punch head receiving portion 82 may be larger than the punch shaft receiving portion 84 and may extend further from the axis 80 than the punch shaft receiving portion 84. The punch head receiving portion 82 may have a shape that is compatible with the punch 44. In the configuration shown in FIG. 3, the punch head receiving portion 82 has a larger diameter than the punch shaft receiving portion 84.

The punch shaft receiving portion 84 may extend from the punch head receiving portion 82 to the bottom surface 76 of the punch lifting plate 42. More specifically, the punch shaft receiving portion 84 may extend from the bottom punch head receiving portion surface 86 to the bottom surface 76. The punch shaft receiving portion 84 may extend along the axis 80 and may have any suitable shape that is compatible with the punch 44.

Referring to FIGS. 2 and 3, the pattern plate 46 may be received in the pattern plate retaining region 50. As will be discussed in more detail below, the pattern plate 46 may help control or establish which punches 44 will penetrate the trim cover 12 when the trim cover perforation apparatus 10 is actuated. The pattern plate 46 may have a set of pattern plate holes 90 that may extend through the pattern plate 46. Each member of the set of pattern plate holes 90 may be aligned with a corresponding punch opening 52. More specifically, each pattern plate hole 90 may be coaxially disposed with the axis 80 and aligned with a punch head receiving portion 82. The pattern plate hole 90 may be sized such that each pattern plate hole 90 can receive the head of a punch 44. As such, each pattern plate hole 90 may be the same size as a punch head receiving portion 82 or larger than a punch head receiving portion 82. Each punch 44 that is aligned with a pattern plate hole 90 may not perforate the trim cover 12 while each punch 44 that is not aligned with a pattern plate hole 90 may perforate the trim cover 12 as will be discussed in more detail below.

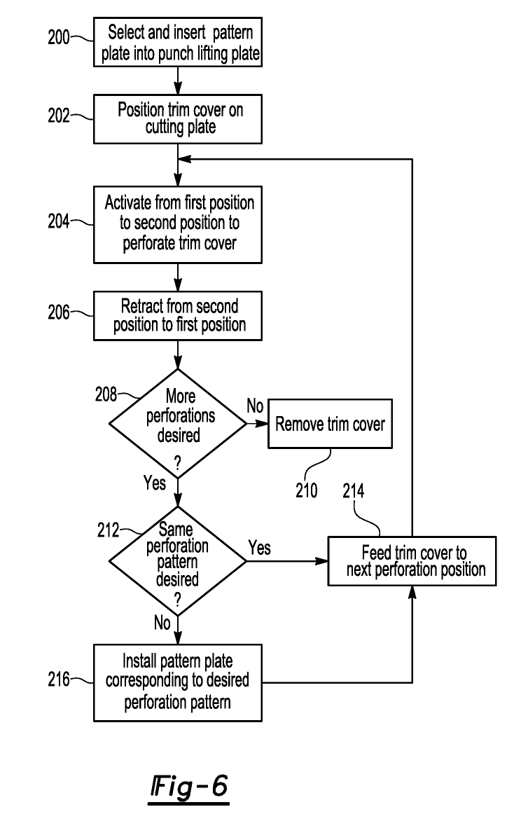

The pattern plate 46 may be provided in various configurations. A pattern plate 46 with a first configuration is shown in FIG. 2. A pattern plate 46′ with a different configuration is shown in FIG. 5. The pattern plates 46, 46′ may generally have the same size and shape except for the number of pattern plate holes 90, the location of the pattern plate holes 90, or both.

Referring to FIG. 3, the punches 44 may be configured to perforate the trim cover 12. A punch 44 may be received in each punch opening 52 of the punch lifting plate 42. More specifically, each punch 44 may extend through the punch lifting plate 42 toward the trim cover 12. Each punch may extend along the axis 80 and may have a punch head 100 and a punch shaft 102.

The punch head 100 may be disposed at an end of the punch 44 that may be disposed proximate the punch lifting plate 42 and the pattern plate 46. The punch head 100 may be configured to retain the punch 44 in the punch opening 52 and prevent the punch from sliding out of the punch opening 52 when the upper portion 30 of the trim cover perforating apparatus 10 is in a retracted position or first position as is best shown in FIG. 3. The punch head 100 may be larger than the punch shaft 102. For instance, the punch head 100 may have a larger diameter than the punch shaft 102. The pattern plate 46 may engage a punch head 100 of each punch 44 that perforates the trim cover 12 as will be discussed in more detail below. The punch head 100 of a punch 44 that does not perforate the trim cover 12 may be move and be received in a pattern plate hole 90 of the pattern plate 46 as will be discussed in more detail below.

The punch shaft 102 may extend from the punch head 100 and may be configured to engage and perforate the trim cover 12. For instance, the punch shaft 102 may extend from the punch head 100 through the punch shaft receiving portion 84 of the punch opening 52 and toward the trim cover 12. The punch shaft 102 may have any suitable configuration. For example, the punch shaft 102 may be substantially cylindrical in one or more embodiments. The punch shaft 102 may be aligned with and may extend through one or more corresponding openings that may be provided with components of the lower portion 32 as will be discussed in more detail below.

Referring again to FIG. 1, the lower portion 32 may be mounted to the bed 24. As such, the lower portion 32 may be stationary and may not move with respect to the upper portion 30. In at least one embodiment, the lower portion 32 may include a cutting plate 110 and a guide plate 112.

Referring to FIGS. 2 and 3, the cutting plate 110 may be disposed in a stationary position with respect to the bed 24 of the press 20. For instance, the cutting plate 110 may be mounted on a surface of the bed 24 that faces toward the ram 22. The cutting plate 110 may support the trim cover 12 such that the trim cover 12 may be disposed between the cutting plate 110 and components of the upper portion 30, such as the punch lifting plate 42.

The cutting plate 110 may have a plurality of holes 120 that may extend through the cutting plate 110. Each hole 120 may be aligned with a punch 44. More specifically, each hole 120 may be disposed along the axis 80 and may be aligned with the punch shaft 102 of a corresponding punch 44. Each hole 120 may be slightly larger than the punch shaft 102. As such, the cutting plate 110 may support the trim cover 12 adjacent to the hole 120 allow the punch shaft 102 to cleanly perforate the trim cover 12.

The guide plate 112, if provided, may be disposed in a stationary position with respect to the cutting plate 110. For example, the guide plate 112 may be mounted to the cutting plate 110 such that the guide plate 112 may be disposed between the punch lifting plate 42 and the cutting plate 110.

The cutting plate 110 and the guide plate 112 may cooperate to define a passage 130. The trim cover 12 may be fed through the passage 130 and may be positioned in the passage 130 when perforations are provided by the trim cover perforating apparatus 10. The guide plate 112 may be disposed above and may be spaced apart from the trim cover 12 when the trim cover 12 is disposed in the passage 130. As such, the guide plate 112 may be disposed between and may be spaced apart from the trim cover 12 and the punch lifting plate 42.

The guide plate 112 may have a second set of punch openings 132 that may extend through the guide plate 112. Each punch opening 132 may be aligned with and may receive a punch 44. More specifically, each punch opening 132 may be disposed along the axis 80 and may be aligned with the punch shaft 102 of a corresponding punch 44. Each punch opening 132 may be slightly larger than the punch shaft 102. The punch openings 132 of the guide plate 112 may help position the punches 44 so that perforations are provided in a desired location. In addition, a punch opening 132 may help inhibit deflection or bending of a corresponding punch shaft 102 to inhibit deformation or damage to a punch 44.

Referring to FIG. 6, a flowchart of an exemplary method of perforating a trim cover with the trim cover perforating apparatus 10 is shown. As will be appreciated by one of ordinary skill in the art, the flowchart represents control logic which may be implemented or affected in hardware, software, or a combination of hardware and software. For example, the various functions may be affected by a controller such as a programmed microprocessor. The control logic may be implemented using any of a number of known programming and processing techniques or strategies and is not limited to the order or sequence illustrated. For instance, interrupt or event-driven processing may be employed in real-time control applications rather than a purely sequential strategy as illustrated. Likewise, parallel processing, multitasking, or multi-threaded systems and methods may be used.

Control logic may be independent of the particular programming language, operating system, processor, or circuitry used to develop and/or implement the control logic illustrated. Likewise, depending upon the particular programming language and processing strategy, various functions may be performed in the sequence illustrated, at substantially the same time, or in a different sequence while accomplishing the method of control. The illustrated functions may be modified, or in some cases omitted, without departing from the scope intended.

At block 200, a pattern plate 46 may be selected and inserted into the pattern plate retaining region 50 of the punch lifting plate 42. The pattern plate 46 may have an arrangement of pattern plate holes 90 that be configured to provide a desired perforation pattern on the trim cover 12. The pattern plate 46 may be inserted into the opening 70 of the punch lifting plate 42 when the trim cover perforating apparatus 10 is disposed in a retracted position or a first position as shown in FIG. 3. In the first position, the ram 22 and the upper portion 30 of the trim cover perforating apparatus 10 may be positioned such that the punches 44 hang down from the punch lifting plate 42 and do not engage the trim cover 12. As such, the punch head 100 of each punch 44 may be disposed in the punch head receiving portion 82 of a corresponding punch opening 52 such that the punch head 100 may be disposed on the bottom punch head receiving portion surface 86. Accordingly, the punches 44 may not be disposed in the pattern plate retaining region 50 or in the pattern plate holes 90 when the trim cover perforating apparatus 10 is in the first position. In addition, the punches 44 may not extend into the cutting plate 110 when the trim cover perforating apparatus 10 is in the first position.

At block 202, the trim cover 12 may be positioned on the cutting plate 110. For example, the trim cover 12 may be fed into the passage 130 between the guide plate 112 and the cutting plate 110 and may rest on the cutting plate 110. The trim cover 12 may be fed to a position at which the punches 44 are positioned over a location at which perforations are to be provided in the trim cover 12. The trim cover 12 may then be held a stationary position.

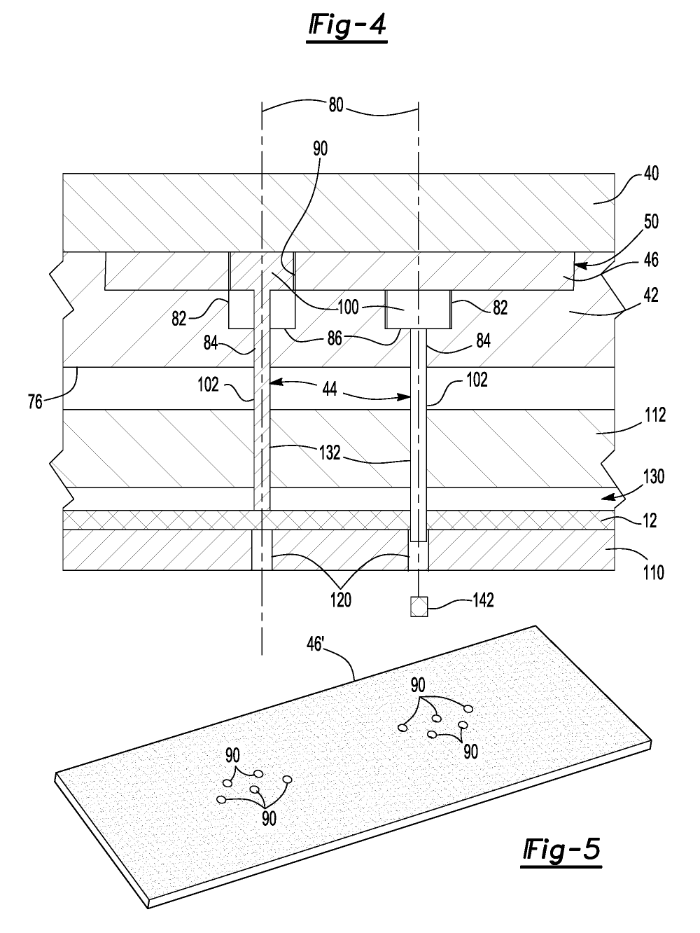

A block 204, the trim cover perforating apparatus 10 may be actuated from the first position to an extended position or a second position to perforate the trim cover 12. The trim cover perforating apparatus 10 is shown in a second position in FIG. 4. In the second position, the ram 22 and the upper portion 30 of the trim cover perforating apparatus 10 may be actuated toward the bed 24. As such, the punches 44 may move together toward the lower portion 32 and may engage the trim cover 12 when the trim cover perforating apparatus 10 moves toward the second position.

Movement to the second position may cause some punches 44 to engage the trim cover 12 without perforating the trim cover 12 while other punches 44 may engage and perforate the trim cover 12 based on the configuration of the pattern plate 46. More specifically, a punch 44 that is aligned with a pattern plate hole 90 may not perforate the trim cover 12 while a punch 44 that is not aligned with a pattern plate hole 90 may perforate the trim cover 12 and form a perforation 140 in the trim cover 12 as is best shown in FIGS. 2 and 4.

A punch 44 that is aligned with a pattern plate hole 90, such as the punch 44 located toward the left of FIG. 4, may move upward along the axis 80 out of the punch head receiving portion 82 of a corresponding punch opening 52 and into a corresponding pattern plate hole 90 when its punch shaft 102 engages the trim cover 12. Such a punch 44 may not perforate the trim cover 12 since the pattern plate 46 does not engage an end of the punch head 100 to exert force that would cause the punch 44 to penetrate the trim cover 12. Since the punch 44 does not perforate the trim cover 12, the punch 44 will not enter a hole 120 in the cutting plate 110.

A punch 44 that is not aligned with a pattern plate hole 90, such as the punch 44 located toward the right of FIG. 4, will not move upward out of the punch head receiving portion 82 of a corresponding punch opening since the pattern plate 46 will engage the end of the punch head 100 to inhibit upward axial movement of the punch 44 along the axis 80. As such, the punch 44 may be held in a substantially stationary position with respect to the punch lifting plate 42 by the pattern plate 46 and will penetrate and perforate the trim cover 12 and extend into a corresponding hole 120 in the cutting plate 110 when the trim cover perforating apparatus 10 is in the second position. The punch shaft 102 of a punch 44 that perforates the trim cover 12 may cut and separate a piece 142 from the trim cover 12 in push the piece 142 through the hole 120 in the cutting plate 110.

At block 206, the trim cover perforating apparatus 10 may be retracted or moved from the second position to the first position. More specifically, the ram 22 of the press 20 may be retracted and the upper portion 30 of the trim cover perforating apparatus 10 may return to the position shown in FIG. 3. Retracting the upper portion 30 of the trim cover perforating apparatus 10 moves the punches 44 away from the trim cover 12 and extracts any punches 44 that perforated the trim cover 12 from the cutting plate 110 and from the corresponding perforation 140 in the trim cover 12. In addition, retracting the upper portion 30 allows a punch 44 that did not perforate the trim cover 12 (i.e., a punch 44 that is aligned with a pattern plate hole 90) to disengage the trim cover 12 return to the position shown in FIG. 3. The punch head 100 of such a punch 44 may exit the pattern plate retaining region 50 and drop from the pattern plate hole 90 back into the punch head receiving portion 82 of the punch opening 52 of the punch lifting plate 42.

A block 208, a determination is made whether additional perforations in the trim cover 12 are desired. If no more perforations are desired, then the method may continue at block 210 where the trim cover 12 may be removed from the trim cover perforating apparatus 10. If additional perforations are desired, then the method may continue at block 212.

At block 212, a determination is made as to whether the same perforation pattern is desired or whether the perforation pattern is to be repeated on the trim cover 12. For example, a determination may be made as to whether the same perforation pattern is desired in an adjacent perforation position or location that is adjacent to the perforations that were provided in the immediately preceding actuation sequence. If the same perforation pattern is desired, then the pattern plate 46 is not replaced and method may continue at block 214. If the same perforation pattern is not desired, then the method may continue at block 216.

At block 214, the trim cover 12 may be advanced or fed to the next perforation position. The trim cover 12 may be fed to the next perforation position manually or with an actuator, such as a roller unit, that may feed or index the trim cover 12 by a desired distance or a predetermined distance. The method may then continue at block 204 and provide additional perforations in the trim cover 12 as previously described.

At block 216, the pattern plate 46 that is currently received in the upper portion 30 may be removed and replaced with a different pattern plate that may be configured to provide the desired perforation pattern (i.e., a different perforation pattern). Such a pattern plate may have a different pattern of pattern plate holes 90 than the previous pattern plate 46. The method may then continue at block 214 where the trim cover 12 may be fed or advanced to the next position at which perforations are to be provided. The method may then continue at block 204 to provide additional perforations in the trim cover 12 that correspond to the currently installed pattern plate 46.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. A trim cover perforating apparatus comprising:
a punch lifting plate that has a pattern plate retaining region and a plurality of punch openings that extend from the pattern plate retaining region;
a cutting plate that supports a trim cover such that the trim cover is disposed between the cutting plate and the punch lifting plate;
a plurality of punches that are received in the punch openings; and
a pattern plate that is received in the pattern plate retaining region and that has a set of pattern plate holes, wherein each punch that is aligned with a member of the set of pattern plate holes moves into a corresponding pattern plate hole and does not perforate the trim cover when the punch lifting plate is actuated toward the trim cover and each punch that is not aligned with a member of the set of pattern plate holes perforates the trim cover when the punch lifting plate is actuated toward the trim cover.

2. The apparatus of claim 1 wherein the punch lifting plate is disposed on a top plate that is disposed on a ram of a press.

3. The apparatus of claim 2 wherein the pattern plate retaining region is disposed adjacent to the top plate such that the pattern plate engages the top plate.

4. The apparatus of claim 2 wherein the punch lifting plate and the top plate define an opening of the pattern plate retaining region through which the pattern plate is inserted and removed from the pattern plate retaining region.

5. The apparatus of claim 1 wherein the pattern plate is inserted and removed from the pattern plate retaining region along a slot axis that is disposed substantially perpendicular to a feed direction of the trim cover.

6. The apparatus of claim 1 wherein the cutting plate is disposed on a bed of a press.

7. The apparatus of claim 1 further comprising a guide plate that is disposed between the punch lifting plate and the cutting plate, wherein the guide plate has a second set of punch openings that receives the punches.

8. The apparatus of claim 7 wherein the guide plate is disposed between the trim cover and the punch lifting plate.

9. The apparatus of claim 8 wherein the guide plate does not engage the trim cover and the punch lifting plate.

10. The apparatus of claim 8 wherein the guide plate is disposed on the cutting plate such that the guide plate and the cutting plate cooperate to define a passage through which the trim cover is fed.

11. The apparatus of claim 8 wherein the trim cover is disposed on the cutting plate and is spaced apart from the guide plate.

12. The apparatus of claim 1 wherein the pattern plate engages a punch head of each punch that is not aligned with a member of the set of pattern plate holes to inhibit punch movement with respect to the punch lifting plate when the pattern plate is actuated toward the trim cover.

13. The apparatus of claim 1 wherein a punch head of each punch that is aligned with a member of the set of pattern plate holes moves into a corresponding member of the set of pattern plate holes when the pattern plate is actuated toward the trim cover.

14. A method of perforating a trim cover with a trim cover perforating apparatus comprising:
positioning a trim cover on a cutting plate of the trim cover perforating apparatus; and
actuating an upper portion of the trim cover perforating apparatus that has a punch lifting plate that receives a plurality of punches and a first pattern plate from a first position in which the punches do not engage the trim cover to a second position in which at least some of the punches perforate the trim cover, wherein the first pattern plate has a set of pattern plate holes that are aligned with some of the punches, wherein each punch that is aligned with a member of the set of pattern plate holes does not perforate the trim cover and each punch that is not aligned with a member of the set of pattern plate holes perforates the trim cover.

15. The method of claim 14 wherein the punches extend through a guide plate that is disposed between and spaced apart from the punch lifting plate and the trim cover.

16. The method of claim 14 wherein each punch that is aligned with a member of the set of pattern plate holes engages the trim cover and moves into a corresponding member of the set of pattern plate holes when the punch lifting plate is actuated from the first position to the second position.

17. The method of claim 14 wherein the first pattern plate engages each punch that is not aligned with a member of the set of pattern plate holes to inhibit axial movement with respect to the punch lifting plate.

18. The method of claim 17 further comprising actuating the punch lifting plate from the second position to the first position and replacing the first pattern plate with a second pattern plate to provide a different perforation pattern.

19. The method of claim 18 further comprising feeding the trim cover to a next perforation position and actuating the punch lifting plate from the first position to the second position to perforate the trim cover with the different perforation pattern.

20. The method of claim 18 wherein the second pattern plate has a different pattern of pattern plate holes than the first pattern plate.
